(19) United States
(12) Patent Application Publication
(10) Pub. No.: US 2012/0207219 A1
(43) Pub. Date: Aug. 16, 2012

(54) PICTURE ENCODING APPARATUS, PICTURE ENCODING METHOD, AND PROGRAM

(76) Inventor: Kiyoto SOMEYA, Tokyo (JP)

(21) Appl. No.: 13/363,981

(22) Filed: Feb. 1, 2012

(30) Foreign Application Priority Data
Feb. 10, 2011 (JP) 2011-027386

(51) Int. Cl. H04N 7/36; H04N 7/26

(52) U.S. Cl. 375/240.16; 375/240.12; 375/E07.255; 375/E07.263; 375/E07.125

(57) ABSTRACT

A picture encoding apparatus includes a feature quantity generation unit and a reference picture list creation unit. The feature quantity generation unit generates feature quantity indicative of dominant one of parallax prediction using reference pictures the viewpoints of which are different from each other and temporal prediction using reference pictures in the temporal direction when a picture is encoded. When an encoding target picture is encoded, the reference picture list creation unit updates a reference picture list including the reference pictures based on the feature quantity generated in a picture which was encoded before the corresponding encoding target picture is encoded.

### BACKGROUND

The present disclosure relates to a picture encoding apparatus, a picture encoding method, and a program which can improve the encoding efficiency of a multi-viewpoint picture.

Recently, apparatuses which manage picture information as digital data, transmit information in high efficiency, and store information during the management, for example, apparatuses based on a method, such as Moving Picture Experts Group (MPEG) or the like, in which compression is performed by orthogonal transform, such as Discrete Cosine Transform (DCT), and motion compensation have become widespread in broadcasting stations and general households.

In particular, MPEG2 (International Organization for Standardization (ISO)/International Electrotechnical Commission (IEC) 138182) has been defined as a general-purpose picture encoding method, and is widely used for a wide range of applications for the professional purposes and consumer purposes at the present time. Furthermore, a picture encoding method, called H.264/Advanced Video Coding (AVC), which enables higher encoding efficiency to be implemented, compared to the encoding method called MPEG2, has been standardized.

In such a picture encoding method, the information amount is compressed by reducing redundancy in the temporal direction and in the spatial direction. For example, in an I-picture in which predictive encoding is performed in a screen for the purpose of the reduction of spatial redundancy, a predictive picture is generated using the relationship between pixels. Further, in a unidirectionally predictive-coded picture (B-picture) in which inter-screen predictive encoding is performed for the purpose of the reduction of temporal redundancy, a predictive picture is generated by detecting motion vectors in units of a block with reference to a forward picture and by using the detected motion vectors. Furthermore, in a bidirectionally predictive-coded picture (B-picture), a predictive picture is generated by detecting motion vectors in units of a block with reference to forward and backward pictures and using the detected motion vectors. Meanwhile, in a B-picture, a first reference picture is called an L0 predictive reference picture and a second reference picture is called an L1 predictive reference picture.

In the H.264/AVC method, reference pictures can be selected from a plurality of pictures which were encoded in advance. Further, the selected reference pictures are managed using an index. The index is used as information which is indicative of a picture which is referred to by detected motion vectors, and is encoded together with the information indicative of the detected motion vectors.

Such an index is set to a value which is 0 or greater. Further, as the value of an index becomes lower, the information amount (encoding amount) obtained after encoding becomes lower. Furthermore, an index can be freely set to be assigned to a reference picture. Therefore, when the index having a small value is assigned to a reference picture in which a large number of motion vectors are referred to, the encoding amount obtained when the index is encoded is reduced, so that encoding efficiency can be improved.

Further, in Japanese Unexamined Patent Application Publication No. 201063092, when a field encoding is performed on a 2Dimensional (2D) picture using an interlaced scanning method, an index having a small value is assigned to a reference picture which is temporally closer to an encoding target picture.

### SUMMARY

However, in Frame Sequential (FS)AVC or Multi-view Video Coding (MVC), parallax prediction using the correlation between pictures which have different viewpoints is performed as well as temporal prediction using the correlation between pictures in the temporal direction.

As described above, when parallax prediction is performed, as well as temporal prediction, in a picture encoding apparatus, it is necessary to assign an index to the parallax prediction.

FIG. 1 is a flowchart illustrating the operation of a general picture encoding apparatus according to the related art. In step ST1, the picture encoding apparatus determines a reference picture list and performs a macroblock loop process. Meanwhile, the reference picture list is a list indicative of the relationship between a picture which is referred to (reference picture) and an index. As the macroblock loop process, the picture encoding apparatus performs motion prediction, intra prediction, and mode determination in step ST2, performs orthogonal transform based on the results of the determination in step ST3, performs quantization in step ST4, and generates encoded streams in step ST5. Further, the picture encoding apparatus performs reverse quantization in step ST6, performs reverse orthogonal transform in step ST7, and generates a reference picture in step ST8. The picture encoding apparatus performs the motion prediction and the intra prediction using the generated reference picture. As described above, since the reference picture list should be defined in advance, when, for example, an index having a small value is assigned to a reference picture which is temporally closer, it is difficult to be guaranteed that an index will be assigned in the order of a picture which is frequently referred to for temporal prediction or parallax prediction.

Further, when it is necessary to sort the reference picture list in the order of pictures which are frequently referred to, it is necessary to perform the macroblock loop process again and determine a picture which is frequently referred to, such that processing time increases. Furthermore, in a rapid encoding process in which real time processing is necessary, there may be a case where the macroblock loop process is not permitted to be performed again.

It is therefore desirable to provide a picture encoding apparatus, a picture encoding method, and a program which can improve encoding efficiency when a multi-viewpoint picture is encoded.

According to an embodiment of the present disclosure, a picture encoding apparatus includes a feature quantity generation unit which generates feature quantity indicative of a dominant one of parallax prediction using reference pictures the viewpoints of which are different from each other and temporal prediction using reference pictures in the temporal direction when a picture is encoded; and a reference picture list creation unit which, when an encoding target picture is encoded, updates the reference picture list of the reference pictures based on the feature quantity generated in a picture which was encoded before the corresponding encoding target picture is encoded.

According to the embodiment of the present disclosure, the feature quantity indicative of the dominant one of the parallax prediction using the reference pictures the viewpoints of which are different from each other and the temporal prediction using reference pictures in temporal direction may be generated when the picture is encoded. For example, the proportion of a block for which the parallax prediction is performed to a block for which the temporal prediction is performed, information indicative of the prediction error of each of the reference pictures obtained by performing the motion prediction on each of the reference pictures of the temporal prediction when the encoding target picture is a bidirectionally predictive-coded picture, or information indicative of the prediction error obtained by performing motion prediction using the reference pictures of the parallax prediction may be generated.

When the encoding target picture is encoded, the reference picture list of the reference pictures may be updated based on the feature quantity generated in the picture which was encoded before the corresponding encoding target picture is encoded, and short code length indexes may be assigned to the reference pictures used in the dominant prediction. Further, with respect to the motion prediction, the motion prediction may be performed for a reference picture represented by an index selected by a block at the same location of the picture which was encoded immediately before the encoding target picture is encoded. When the prediction error is lower than a preset threshold, the motion prediction may be terminated. Furthermore, when the prediction error is greater than the threshold, the motion prediction may be performed using the reference pictures in the order of dominant predictions. When the prediction error is lower than the threshold, the motion prediction may be terminated.

According to another embodiment of the present disclosure, a picture encoding method includes generating feature quantity indicative of dominant one of parallax prediction using reference pictures the viewpoints of which are different from each other and temporal prediction using reference pictures in a temporal direction when a picture is encoded; and, when an encoding target picture is encoded, updating the reference picture list of the reference pictures based on the feature quantity generated in a picture which was encoded before the corresponding encoding target picture is encoded.

According to still another embodiment of the present disclosure, a program causes a picture to be encoded in a computer, and includes generating feature quantity indicative of a dominant one of parallax prediction using reference pictures the viewpoints of which are different from each other and temporal prediction using reference pictures in the temporal direction when a picture is encoded; and, when an encoding target picture is encoded, updating the reference picture list of the reference pictures based on the feature quantity generated in a picture which was encoded before the corresponding encoding target picture is encoded.

Meanwhile, a computer program according to the embodiment of the present disclosure may be a computer program which can be provided to, for example, a general-purpose computer system which can execute various types of program codes, with a storage medium and a communication medium which are provided in a computer readable format, for example, a storage medium such as an optical disc, a magnetic disk and a semiconductor memory, or a communication medium such as a network. Since such a program is provided in a computer readable format, a process according to the program is realized on a computer system.

According to the embodiments of the present disclosure, feature quantity indicative of a dominant one of parallax prediction using reference pictures the viewpoints of which are different from each other and temporal prediction using reference pictures in temporal direction is generated when a picture is encoded. When an encoding target picture is encoded, the reference picture list of the reference pictures is updated based on the feature quantity generated in a picture which was encoded before the corresponding encoding target picture is encoded. Therefore, when a multi-viewpoint picture is encoded, an index can be assigned such that encoding amount of the reference picture is reduced, and encoding efficiency can be improved.

### BRIEF DESCRIPTION OF THE DRAWINGS

FIG. 1 is a flowchart illustrating the operation of a general picture encoding apparatus according to the related art;

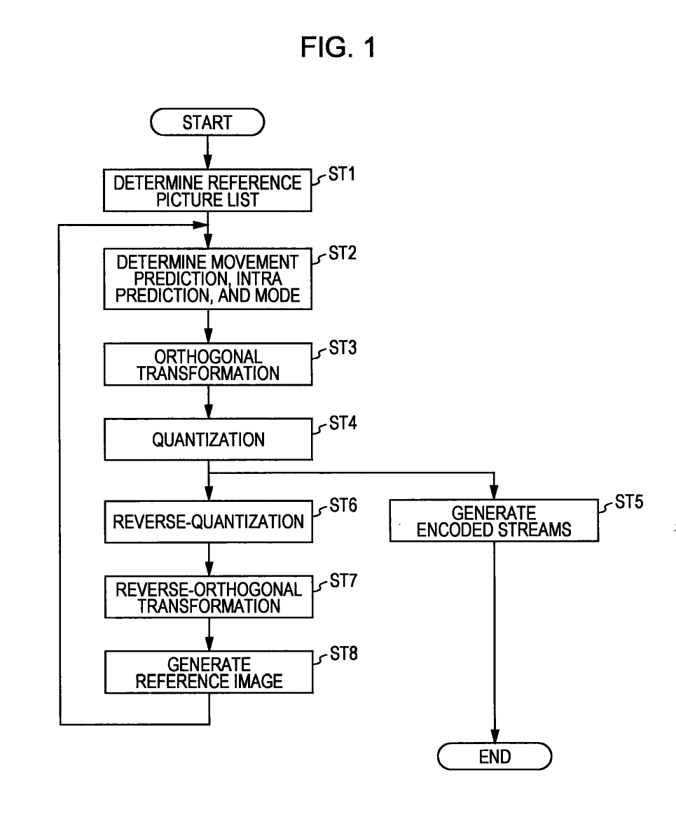

FIG. 2 is a view illustrating the configuration of a picture encoding apparatus;

FIG. 3 is a flowchart illustrating a process performed for each encoding target picture;

FIG. 4 is a flowchart illustrating another process performed for each encoding target picture;

FIG. 5 is a flowchart illustrating an encoding process when an encoding target picture is a B-picture;

FIG. 6 is a view illustrating the detailed operation of the picture encoding apparatus;

FIG. 7 is a flowchart illustrating an operation when a rapid encoding process is promoted based on information indicative of the proportion of parallax prediction to temporal prediction;

FIG. 8 is a flowchart illustrating an operation when a rapid encoding process is promoted based on information indicative of a reference picture which is referred to for each macroblock;

FIG. 9 is a flowchart illustrating an operation when a rapid encoding process is promoted based on information indicative of the proportion of the parallax prediction to the temporal prediction and information indicative of a reference picture selected for each macroblock; and

FIG. 10 is a view illustrating the configuration of a computer apparatus.

### DETAILED DESCRIPTION OF EMBODIMENTS

Embodiments of the present disclosure will be described below. Further, description will be performed as follows:

1. Configuration of picture encoding apparatus

2. First operation of picture encoding apparatus

3. Second operation of picture encoding apparatus

4. Example of operation of picture encoding apparatus

5. Third operation of picture encoding apparatus

6. Case of software processing

1.Configuration of Picture Encoding Apparatus

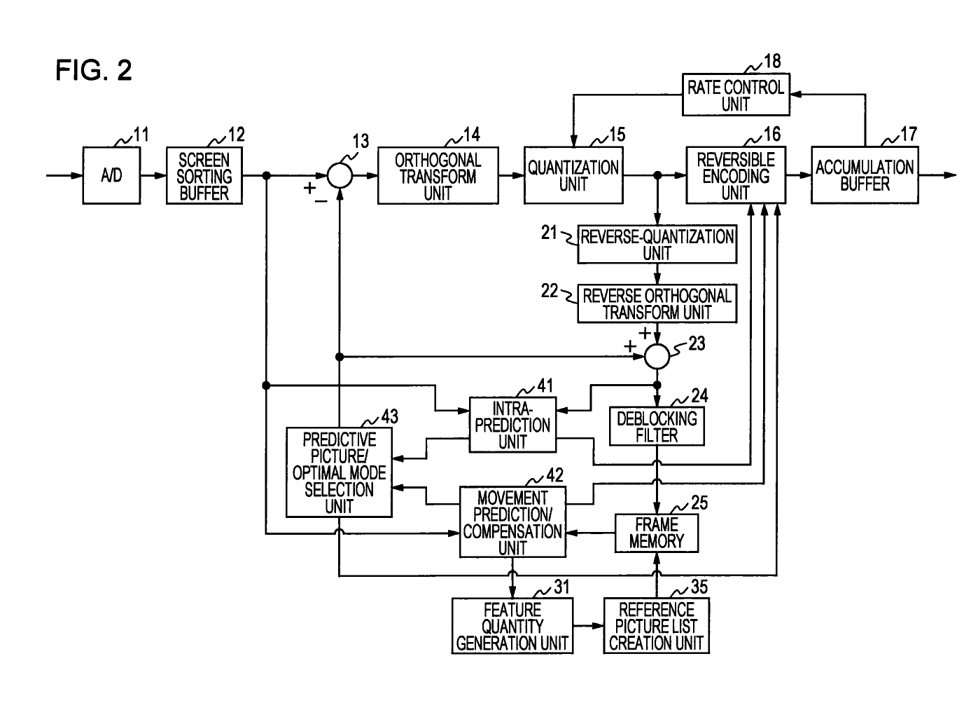

FIG. 2 illustrates the configuration of a picture encoding apparatus 10. The picture encoding apparatus 10 includes an Analog-to-Digital converter (A/D converter) 11, a screen sorting buffer 12, a subtraction unit 13, an orthogonal transform unit 14, a quantization unit 15, a reversible encoding unit 16, an accumulation buffer 17, and a rate control unit 18. Further, the picture encoding apparatus 10 includes a reverse quantization unit 21, a reverse orthogonal transform unit 22, an addition unit 23, a deblocking filter 24, and a frame memory 25. Furthermore, the picture encoding apparatus 10 includes a feature quantity generation unit 31, a reference picture list creation unit 35, an intra prediction unit 41, a motion prediction/compensation unit 42, and a predictive picture/optimal mode selection unit 43.

The A/D converter 11 converts an analog picture signal into digital picture data and outputs the digital picture data to the screen sorting buffer 12.

The screen sorting buffer 12 performs frame sorting on the picture data which was output from the A/D converter 11. The screen sorting buffer 12 sorts frames based on a Group Of Picture (GOP) structure related to an encoding process, and outputs the picture data obtained after sorting is performed to the subtraction unit 13, the intra prediction unit 41, and the motion prediction/compensation unit 42.

The subtraction unit 13 receives the picture data, output from the screen sorting buffer 12, and predictive picture data, selected by the predictive picture/optimal mode selection unit 43 which will be described later. The subtraction unit 13 calculates prediction error data indicative of difference between the picture data output from the screen sorting buffer 12 and predictive picture data supplied from the predictive picture/optimal mode selection unit 43, and outputs the calculated prediction error data to the orthogonal transform unit 14.

The orthogonal transform unit 14 performs orthogonal transform process, such as discrete cosine transform (DCT) or Karhunen-Loeve Transform (KLT), on the prediction error data output from the subtraction unit 13. The orthogonal transform unit 14 outputs transform coefficient data, obtained by performing the orthogonal transform process, to the quantization unit 15.

The quantization unit 15 receives the transform coefficient data output from the orthogonal transform unit 14 and a rate control signal output from the rate control unit 18 which will be described later. The quantization unit 15 quantizes the transform coefficient data, and outputs the quantized data to the reversible encoding unit 16 and the reverse quantization unit 21. Further, the quantization unit 15 changes a quantization parameter (quantization scale) based on the rate control signal from the rate control unit 18, thereby changing the bit rate of the quantized data.

The reversible encoding unit 16 receives the quantized data, output from the quantization unit 15, and prediction mode information from the intra prediction unit 41, the motion prediction/compensation unit 42, and the predictive picture/optimal mode selection unit 43 which will be described later. Meanwhile, the prediction mode information includes a macroblock type, which indicates the block size of an encoding target block, and a prediction mode. The reversible encoding unit 16 performs the encoding process on the quantized data using, for example, variable length coding or arithmetic coding, generates encoded streams, and outputs the generated encoded streams to the accumulation buffer 17. Further, the reversible encoding unit 16 performs reversible encoding on the prediction mode information, and adds the resulting information to, for example, the header information of the encoded streams. Furthermore, the reversible encoding unit 16 encodes information used to designate a reference picture and includes the encoded information in the encoded streams.

The accumulation buffer 17 stores the encoded streams from the reversible encoding unit 16. Further, the accumulation buffer 17 outputs the stored encoded streams based on the transmission speed of a transmission path.

The rate control unit 18 monitors the empty space of the accumulation buffer 17, generates the rate control signal based on the empty space, and outputs the rate control signal to the quantization unit 15. The rate control unit 18 obtains, for example, information indicative of the empty space from the accumulation buffer 17. When empty space becomes small, the rate control unit 18 lowers the bit rate of the quantized data in response to the rate control signal. Further, when the empty space of the accumulation buffer 17 is sufficiently large, the rate control unit 18 increases the bit rate of the quantized data in response to the rate control signal.

The reverse quantization unit 21 performs a reverse quantization process on the quantized data supplied from the quantization unit 15. The reverse quantization unit 21 outputs the transform coefficient data, obtained by performing the reverse quantization process, to the reverse orthogonal transform unit 22.

The reverse orthogonal transform unit 22 outputs data, obtained by performing a reverse quantization orthogonal transform process on the transform coefficient data supplied from the reverse quantization unit 21, to the addition unit 23.

The addition unit 23 generates the picture data of the reference picture by adding the data supplied from the reverse orthogonal transform unit 22 to the predictive picture data supplied from the predictive picture/optimal mode selection unit 43, and outputs the picture data to the deblocking filter 24 and the intra prediction unit 41.

The deblocking filter 24 performs a filtering process in order to decrease block distortion generated when a picture is encoded. The deblocking filter 24 performs the filtering process in order to remove the block distortion from the picture data supplied from the addition unit 23, and outputs the picture data, obtained after the filtering process is performed, to the frame memory 25.

The frame memory 25 stores the picture data supplied from the deblocking filter 24 after the filtering process is performed and the picture data of the reference picture supplied from the picture encoding apparatus which performs base view encoding.

The feature quantity generation unit 31 generates feature quantity indicative of the dominant one of temporal prediction and viewpoint prediction in a picture. For example, the feature quantity is information indicative of the dominant one of a temporal prediction block using a reference picture in the temporal direction and a parallax prediction block using a reference picture which has a different viewpoint in a picture when encoding is performed on a dependent view block. The feature quantity generation unit 31 calculates the proportion of a parallax prediction block to a temporal prediction block in the picture as the feature quantity. Further, the feature quantity generation unit 31 calculates a prediction error (ME error) by performing motion prediction in units of a block using the reference picture, and uses the ME residual of a single picture as the feature quantity. As described above, the feature quantity generation unit 31 generates the feature quantity, and outputs the generated feature quantity to the reference picture list creation unit 35.

The reference picture list creation unit 35 updates the reference picture list of reference pictures based on the feature quantity generated by the feature quantity generation unit 31. In detail, the reference picture list creation unit 35 updates the reference picture list based on the feature quantity, and creates the reference picture list in which a short code length index is assigned to a reference picture which is used in the dominant prediction.

For example, when the proportion of the parallax prediction block to the temporal prediction block is used as the feature quantity, the reference picture list creation unit 35 uses the reference picture list in which a short code length index is assigned to a reference picture which is used in the prediction of proportion which is high. Further, for example, when ME residual is used as the feature quantity, the reference picture list creation unit 35 uses the reference picture list in which a short code length index is assigned to a reference picture in which the ME residual is low. Meanwhile, the reference picture list creation unit 35 uses a predetermined initial reference picture list when encoding is performed on an initial picture.

The intra prediction unit 41 performs an intra prediction process using the picture data of the encoding target picture, output from the screen sorting buffer 12, and the picture data, supplied from the addition unit 23, in all the candidate intra prediction modes. Furthermore, the intra prediction unit 41 calculates the value of a cost function in each intra prediction mode, and selects an intra prediction mode in which the calculated value of the cost function is the smallest, that is, the intra prediction mode in which encoding efficiency becomes optimal, as an optimal intra prediction mode. The intra prediction unit 41 outputs predictive picture data generated in the optimal intra prediction mode, prediction mode information related to the optimal intra prediction mode, and the value of the cost function in the optimal intra prediction mode to the predictive picture/optimal mode selection unit 43. Further, in order to obtain the generated encoding amount used to calculate the value of the cost function, the intra prediction unit 41 outputs the prediction mode information related to the intra prediction mode to the reversible encoding unit 16 in the intra prediction process in each intra prediction mode. Meanwhile, when the value of the cost function is generated, for example, a method implemented in reference software in conformity with H.264AVC called Joint Model (JM) can be mentioned.

The motion prediction/compensation unit 42 performs a motion prediction/compensation process on each block size of the encoding target block. The motion prediction/compensation unit 42 detects motion vectors for each block-sized picture of the picture read from the screen sorting buffer 12 using the picture data, read from the frame memory 25 and obtained after the deblocking filtering process, and the picture data of a base view. Furthermore, the motion prediction/compensation unit 42 generates a predictive picture by performing a motion compensation process on the reference picture based on the detected motion vectors.

Further, the motion prediction/compensation unit 42 generates the value of the cost function for each block size of the encoding target block and each reference picture, and selects the block size and the reference picture, in which the value of the cost function is the smallest, as the optimal intra prediction mode. The motion prediction/compensation unit 42 outputs the predictive picture data generated in the optimal intra prediction mode, the prediction mode information related to the optimal intra prediction mode, and the value of the cost function in the optimal intra prediction mode to the predictive picture/optimal mode selection unit 43. Further, the motion prediction/compensation unit 42 outputs the prediction mode information related to the inter prediction mode to the reversible encoding unit 16 in an inter prediction process in each block size in order to obtain the generated encoding amount used to generate the value of the cost function.

The predictive picture/optimal mode selection unit 43 compares the value of the cost function supplied from the intra prediction unit 41 with the value of the cost function supplied from the motion prediction/compensation unit 42, and selects the one of them which has the smaller value of the cost function, as the optimal mode in which the encoding efficiency is the optimal. Further, the predictive picture/optimal mode selection unit 43 outputs predictive picture data generated in the optimal mode to the subtraction unit 13 and the addition unit 23. Furthermore, the predictive picture/optimal mode selection unit 43 outputs the prediction mode information (a macroblock type, a prediction mode, and an index) of the optimal mode to the reversible encoding unit 16. Meanwhile, the predictive picture/optimal mode selection unit 43 performs intra prediction or inter prediction in units of a picture or a slice.

Meanwhile, when encoding is performed on picture data using a Frame Sequential (FS) AVC method in which transform is performed on pictures having different viewpoints in units of a frame, the feature quantity generation unit 31 generates feature quantity using picture data having another viewpoint and extracted from input picture data. Further, the frame memory 25 stores the picture data, having another viewpoint and extracted from the input picture data, or the picture data of a reference picture generated by encoding the picture data having another viewpoint. With the above-described process, the picture data can be encoded using the FS method.

2. First Operation of Picture Encoding Apparatus

Next, the first operation of the picture encoding apparatus will be described. When a picture is encoded, the proportion of the parallax prediction or the temporal prediction have the similar tendencies in the same scene. Therefore, when an encoding target picture is encoded in the first operation, the encoding efficiency of a multi-viewpoint picture can be improved by updating the reference picture list of reference pictures based on feature quantity generated in a picture which was encoded before the encoding target picture is encoded. Further, the first operation shows a case where information, which is indicative of the proportion of a block on which parallax prediction is performed to a block on which temporal prediction is performed in a picture which was encoded immediately before the encoding target picture, is used as the feature quantity.

The information, which is indicative of the proportion of the block in which parallax prediction is performed and the block in which temporal prediction is performed, means, for example, the proportion in which each of the macroblocks selects an index ref_idx assigned to each of the reference pictures. In detail, it is assumed that, in the picture which was encoded before the encoding target picture is encoded, macroblocks in which a reference picture is selected in the parallax direction correspond to 20%, macroblocks in which a reference picture is selected in the temporal direction correspond to 70%, and intra prediction macroblocks correspond to 10%. In this case, the proportion of the parallax prediction to the temporal prediction is

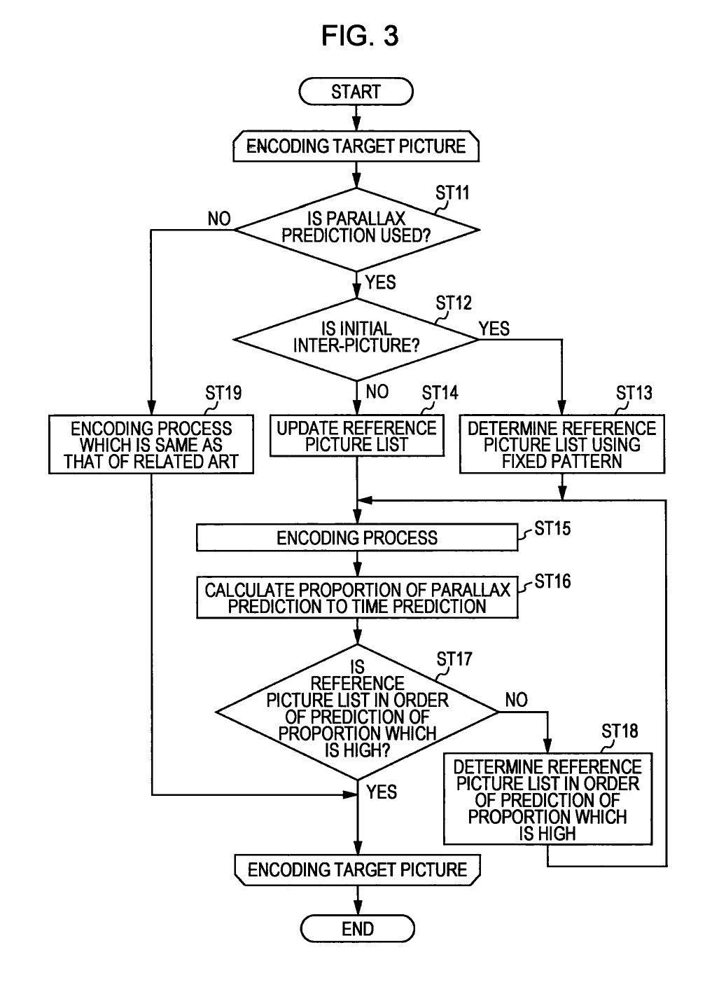

FIG. 3 is a flowchart illustrating a process performed for each encoding target picture.

In step ST11, the picture encoding apparatus 10 determines whether to use the parallax prediction. The picture encoding apparatus 10 proceeds to step ST12 when the parallax prediction is used, and proceeds to step ST19 when the parallax prediction is not used.

In step ST12, the picture encoding apparatus 10 determines whether an encoding target picture is an initial inter picture. The picture encoding apparatus 10 proceeds to step ST13 when the encoding target picture is the initial inter picture, and proceeds to step ST14 when the encoding target picture is not the initial inter picture.

In step ST13, the picture encoding apparatus 10 determines a reference picture list using a fixed pattern. The picture encoding apparatus 10 determines the initial reference picture list of a preset fixed pattern based on the fact that the encoding target picture is the initial picture and the proportion of the parallax prediction to the temporal prediction are not obtained in a picture which was encoded immediately before, and proceeds to step ST15.

In step ST14, the picture encoding apparatus 10 updates the reference picture list. The picture encoding apparatus 10 obtains the proportion of the parallax prediction to the temporal prediction of the picture encoded immediately before based on the fact that the encoding target picture is not the initial picture. Therefore, the picture encoding apparatus 10 updates the reference picture list based on the proportion of the parallax prediction to the temporal prediction of the picture encoded immediately before, and proceeds to step ST15. In detail, the reference picture list, in which a short code length index is assigned to the reference picture which is used for prediction of proportion which is high, is updated.

In step ST15, the picture encoding apparatus 10 performs the encoding process. The picture encoding apparatus 10 performs the encoding process on the encoding target picture, and proceeds to step ST16.

In step ST16, the picture encoding apparatus 10 calculates the proportion of the parallax prediction to the temporal prediction. The picture encoding apparatus 10 calculates the proportion of the parallax prediction to the temporal prediction based on the proportion of a macroblock on which the parallax prediction is performed to a macroblock on which the temporal prediction is performed in the encoding process of the encoding target picture. Further, the picture encoding apparatus stores the calculated proportion such that the proportion can be used in a subsequent encoding target picture, and proceeds to step ST17.

In step ST17, the picture encoding apparatus 10 determines whether the reference picture list is sorted in the order of prediction of proportion which is high. When the reference picture list is sorted in the order of prediction of proportion which is high, the picture encoding apparatus 10 terminates the encoding process of the encoding target picture. Further, when the reference picture list is not sorted in the order of prediction of proportion which is high, the picture encoding apparatus 10 proceeds to step ST18.

In step ST18, the picture encoding apparatus 10 updates the reference picture list such that the reference picture list is sorted in the order of prediction of proportion which is high. That is, the picture encoding apparatus 10 updates the reference picture list such that a short code length index is assigned to the reference picture used for prediction of proportion which is high, returns to step ST15, and performs the encoding process again.

Meanwhile, if the process proceeds from step ST11 to step ST19 since the parallax prediction is not used, the picture encoding apparatus 10 performs the related art encoding process in which the parallax prediction is not used.

If the encoding process is performed as described above, the encoding process is not repeatedly performed when the amount of variation in the proportion of the parallax prediction to the temporal prediction is small because, for example, the scene is the same. Therefore, the picture encoding apparatus 10 can rapidly perform the encoding process without decreasing encoding efficiency. Further, when the prediction of proportion which is high is varied, the reference picture list is updated based on the proportion, and the encoding process is performed again, so that the picture encoding apparatus 10 can perform the encoding process with high encoding efficiency.

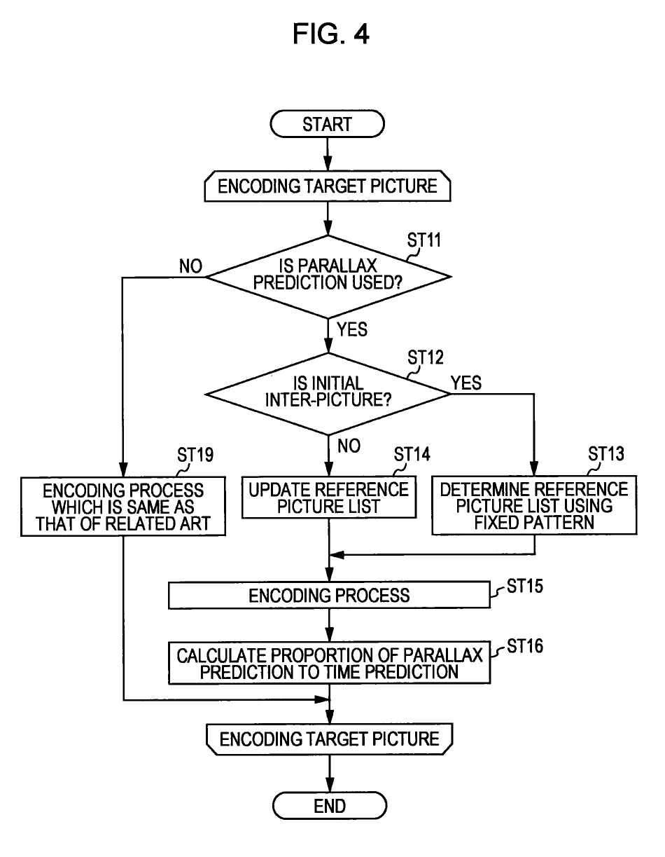

However, in the process shown in FIG. 3, when the amount of variation in the proportion of the parallax prediction to the temporal prediction is large, the encoding process is repeated many times, such that the encoding process takes a time. Here, if the picture encoding apparatus 10 does not perform the processes in steps ST17 and ST18 of FIG. 3 as shown in FIG. 4, it is possible to prevent the time taken for the encoding process from being long even when the amount of variation in the proportion of the parallax prediction to the temporal prediction is large. Meanwhile, there may be a case where the encoding efficiency is lowered in the process shown in FIG. 4, compared to the process shown in FIG. 3. For example, when the encoding process is not repeated and a scene in which the proportion of the temporal prediction is high and a scene in which the proportion of the parallax prediction is high are included, the encoding efficiency of one of the scenes is lowered, compared to the process shown in FIG. 3.

3. Second Operation of Picture Encoding Apparatus

Next, in the second operation, a case where the encoding target picture is a B-picture will be described. When the encoding target picture is a B-picture, the picture encoding apparatus 10 updates reference picture lists L0 and L1 related to the B-picture based on information indicative of the proportion of the parallax prediction to the temporal prediction. Meanwhile, the reference picture list L0 is a list which indicates the reference picture index of L0 prediction and the reference picture list L1 is a list which indicates the reference picture index of L1 prediction.

In the case of the B-picture, a parallax reference picture can be inserted into any one of the reference picture lists L0 and L1. Therefore, in an initial reference picture list, the parallax reference picture is generally inserted into any one of the reference picture lists L0 and L1. Further, in the second operation, the reference picture lists are updated, and a reference picture, in which the prediction error (ME residual) of the motion prediction of each reference picture in the temporal direction is the smallest, is assigned to a reference picture list which is different from the reference picture list including reference pictures in the parallax direction. When the reference picture is assigned as described above, prediction can be performed using both reference pictures which are most frequently referred to the temporal prediction and in the parallax prediction (Bi direction), thereby increasing encoding efficiency.

Further, even in the B-picture, the tendency of the proportion of the parallax prediction to the temporal prediction is similar in the same scene. Therefore, a reference picture in which ME residual is the smallest from among the reference pictures in the temporal direction is assigned to the reference picture list which is different from the reference picture list including reference pictures in the parallax direction. As described above, the assignment to the reference picture lists is performed, and the reference picture lists are updated based on the proportion of the parallax prediction to temporal prediction as in the above-described first operation, so that the same efficiency as that of the first operation can be expected.

Furthermore, in the second operation, if the ME residual is calculated using the reference pictures in the parallax direction by calculating the ME residual of each reference picture in the temporal direction, the assignment to the reference picture lists can be realized in the order of small ME residual, including parallax prediction as well as temporal prediction.

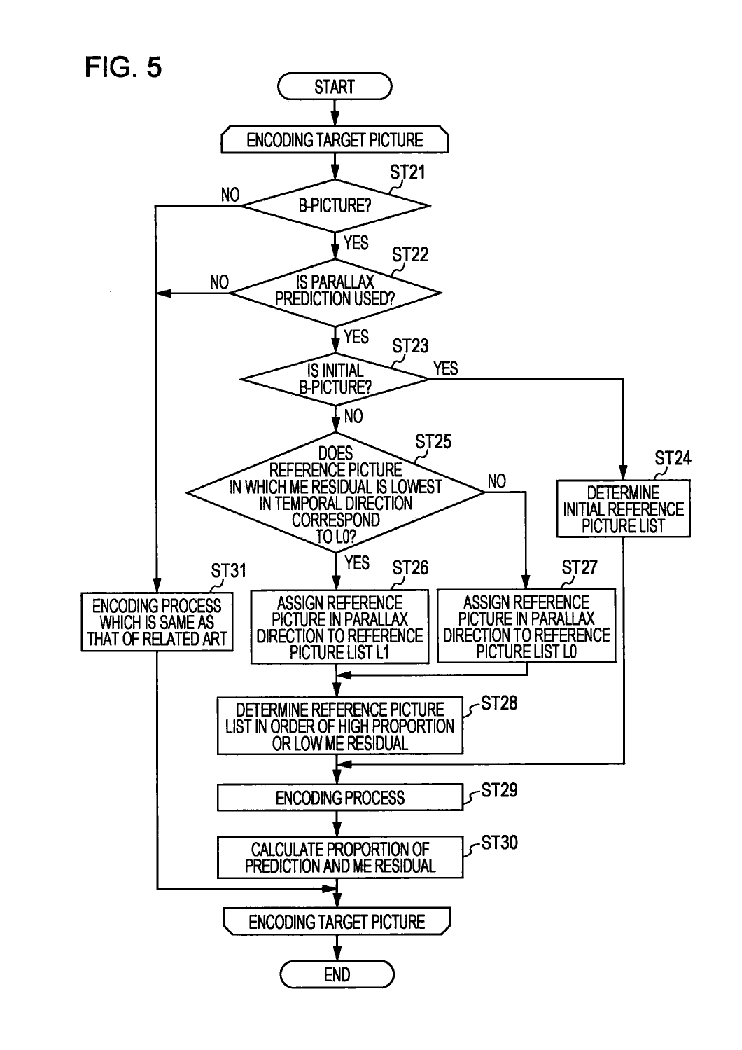

FIG. 5 is a flowchart illustrating an encoding process when the encoding target picture is a B-picture.

In step ST21, the picture encoding apparatus 10 determines whether the encoding target picture is a B-picture. The picture encoding apparatus 10 proceeds to step ST22 when the encoding target picture is a B-picture, and picture encoding apparatus 10 proceeds to step ST31 when the encoding target picture is not a B-picture.

In step ST22, the picture encoding apparatus 10 determines whether to use the parallax prediction. The picture encoding apparatus 10 proceeds to step ST23 when the parallax prediction is used in the encoding process, and the picture encoding apparatus 10 proceeds to step ST31 when the parallax prediction is not used.

In step ST23, the picture encoding apparatus 10 determines whether the encoding target picture is an initial B-picture. The picture encoding apparatus 10 proceeds to step ST24 when the encoding target picture is the initial B-picture, and picture encoding apparatus 10 proceeds to step ST25 when the encoding target picture is not the initial B-picture.

In step ST24, the picture encoding apparatus 10 determines the initial reference picture lists L0 and L1. The picture encoding apparatus 10 determines the initial reference picture lists L0 and L1 of a preset specific pattern based on the fact that the encoding target picture is the initial B-picture and the ME residual is not calculated, and then proceeds to step ST29.

In step ST25, the picture encoding apparatus 10 determines whether a reference picture, in which the ME residual is the smallest, in the temporal direction corresponds to L0 prediction. The picture encoding apparatus 10 proceeds to step ST26 when the reference picture, in which the ME residual is the smallest, in the temporal direction is included in the reference picture list L0, and proceeds to step ST27 when the reference picture is not included in the reference picture list L0.

In step ST26, the picture encoding apparatus 10 assigns the reference picture in the parallax direction to the reference picture list L1, and proceeds to step ST28.

In step ST27, the picture encoding apparatus 10 assigns the reference picture in the parallax direction to the reference picture list L0, and proceeds to step ST28.

In step ST28, the picture encoding apparatus 10 determines the reference picture list in the order of the higher proportion of the parallax prediction and the temporal prediction or in the order of small ME residual, and proceeds to ST29.

In step ST29, the picture encoding apparatus 10 performs the encoding process. The picture encoding apparatus 10 performs the encoding process on the encoding target picture, and proceeds to step ST30.

In step ST30, the picture encoding apparatus 10 calculates the proportion of the parallax prediction to the temporal prediction and the ME residual. The picture encoding apparatus 10 calculates the proportion of the parallax prediction to the temporal prediction for each macroblock of the encoding target picture based on any one of the reference picture in the parallax direction or the reference picture in the temporal direction, which is referred to, in the encoding target picture encoding process. Further, the picture encoding apparatus 10 calculates the ME residual in the encoding target picture encoding process. Furthermore, the picture encoding apparatus 10 stores the calculated proportion and the ME residual such that the proportion and the ME residual can be used for the subsequent encoding target picture, and terminates the encoding target picture encoding process.

Further, when the encoding target picture is not the B-picture and when the parallax prediction is not used, the picture encoding apparatus 10 performs the same encoding process as in the related art in step ST31.

When the above-described encoding process is performed, the picture encoding apparatus 10 can obtain the same efficiency as that of the first operation. Furthermore, even when the L0 prediction and L1 prediction are performed on the Bi-picture, the picture encoding apparatus 10 can determine the reference picture lists L0 and L1 such that encoding efficiency increases. Meanwhile, the second operation may be performed in combination with the first operation.

4. Example of Operation of Picture Encoding Apparatus

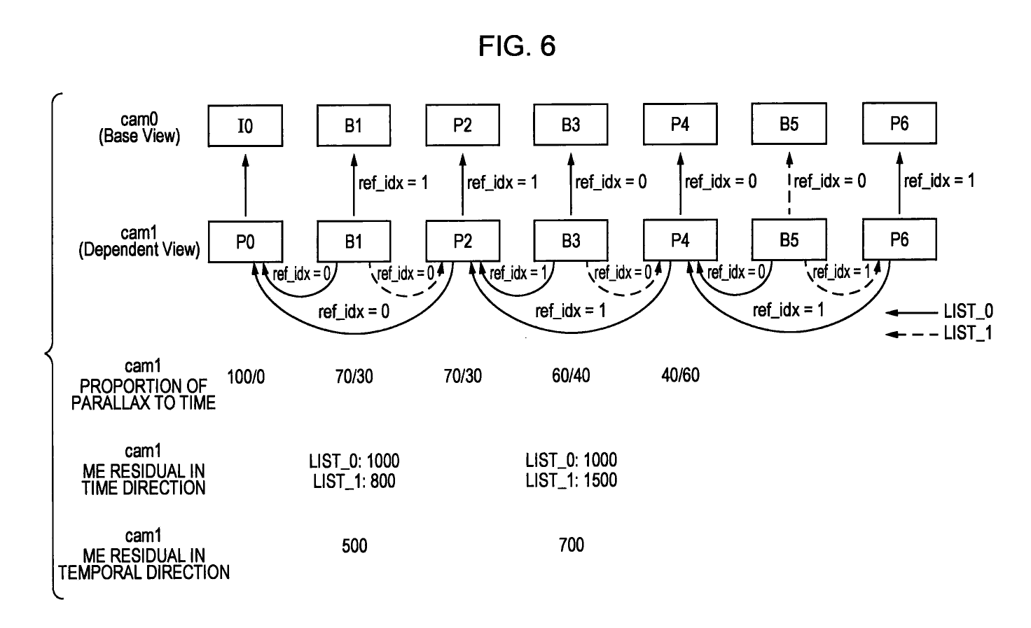

FIG. 6 illustrates the detailed operation of the picture encoding apparatus. For example, Cam0 is the picture data of the viewpoint from the left side, and Cam1 is the picture data of the viewpoint from the right side. Further, the picture data of Cam1 is the picture data of a dependent view in which encoding is performed using the picture data of Cam0 as the picture data of the reference picture. Furthermore, the picture data referred to when the picture data of the dependent view is encoded is the picture data of a base view.

With respect to the unidirectional predictive P-picture of the picture data of Cam1, for example, the reference picture list L0 (LIST_0) uses the P-picture of Cam1 referred to in forward prediction and the P-picture of Cam0 referred to in parallax prediction as reference pictures, as shown using the solid line arrows. However, with respect to the anchor P-picture of the head of GOP, since the P-picture referred to in the forward prediction is not present only the P-picture of Cam0 referred to in the parallax prediction is used as a reference picture.

With respect to B-pictures, the reference picture list L0 (LIST_0) uses the P-picture of Cam1 referred to in the forward prediction and the B-picture of Cam0 referred to in the parallax prediction as the reference pictures, as shown using solid arrows. Further, the reference picture list L1 (LIST_1) uses the P-picture of Cam1 referred to in backward prediction and the B-picture of Cam0 referred to in the parallax prediction as reference pictures, as shown using dotted arrows. However, the B-picture of Cam0 referred to in the parallax prediction can be assigned to only any one of the reference picture lists L0 and L1.

Two reference pictures which can be used in a LIST_X (X is 0 or 1) are managed using a number, called an index ref_idx, and a value which is “0” or greater is assigned thereto. Further, variable length encoding is performed on the index ref_idx, and then the resulting index ref_idx is included in picture data obtained after encoding. Meanwhile, the P2 picture of Cam1 of FIG. 6 illustrates a case where “index ref_idx=0” is assigned to the reference picture of the temporal prediction and “index ref_idx=1” is assigned to the reference picture of the parallax prediction. Further, when the variable length encoding is performed on the index ref_idx, for example, the code length of the “index ref_idx=0” is shorter than the code length of the “index ref_idx=1”.

Based on the above-described preconditions, for example, when the proportion of the parallax prediction to the temporal prediction of the P2 picture of the Cam1 is 70/30(%), the proportion in which parallax is referred to is high. Therefore, in the reference picture list of the subsequent P4 picture of Cam1, “index ref_idx=0” is assigned to the reference picture of the parallax prediction and “index ref_idx=1” is assigned to the reference picture of the temporal prediction.

Next, for example, in the B1-picture of Cam1, the ME residual of the reference picture of the reference picture list L0 (LIST_0) in the temporal direction is set to “1000”, and the ME residual of the reference picture of the reference picture list L1 (LIST_1) in the temporal direction is set to “800”. In this case, since the ME residual of the reference picture list L1 in the temporal direction is low, “index ref_idx=0” is assigned to the reference picture of the B3-picture of Cam1, in which the ME residual is low. Furthermore, when, for example, the proportion of the parallax prediction to the temporal prediction is 70/30(%), the proportion in which parallax is referred to is high. Therefore, in the reference picture list L0 (LIST_0) of the B3-picture of Cam1, “index ref_idx=0” is assigned to the reference picture of the parallax prediction and “index ref_idx=1” is assigned to the reference picture of the temporal prediction. Further, the reference picture list may be determined using the ME residual of the reference picture in the parallax direction. For example, when the ME residual of the reference picture in the parallax direction is set to “500”, the ME residual of the reference picture in the parallax direction is low. Therefore, in the reference picture list L0 (LIST_0) of the B3-picture of Cam1, “index ref_idx=0” is assigned to the reference picture of the parallax prediction and “index ref_idx=1” is assigned to the reference picture of the temporal prediction.

Next, in the B3-picture of Cam1, the ME residual of the reference picture of the reference picture list L0 (LIST_0) in the temporal direction is set to “1000”, and the ME residual of the reference picture of the reference picture list L1 (LIST_1) in the temporal direction is set to “1500”. In this case, since the ME residual of the reference picture list L0 (LIST_0) in the temporal direction is low, the reference picture of a subsequent B5-picture of Cam1 in the parallax direction is assigned to the reference picture list L1 (LIST_1). Furthermore, when, for example, the proportion of the parallax prediction to the temporal prediction is 60/40(%), the proportion of the parallax prediction is high. Therefore, in the reference picture L1 (LIST_1) of the B5 picture of Cam1, “index ref_idx=0” is assigned to the reference picture of the parallax prediction and “index ref_idx=1” is assigned to the reference picture of the temporal prediction. Here, the assignment of the index to the reference picture list L1 (LIST_1) may be performed using the ME residual of the reference picture in the parallax direction. For example, when the ME residual of the reference picture in the parallax direction is set to “700”, the ME residual of the reference picture in the parallax direction is low. In this case, in the reference picture list L1 (LIST_1) of the B5 picture of Cam1, “index ref_idx=0” is assigned to the reference picture of the parallax prediction and “index ref_idx=1” is assigned to the reference picture of the temporal prediction.

As described above, when the first and second operations are performed and the reference picture lists are updated based on the feature quantity, an index having a small value can be assigned to the reference picture of the prediction of proportion which is high or the reference picture having low ME residual. Therefore, the picture encoding apparatus 10 can increase encoding efficiency.

5. Third Operation of Picture Encoding Apparatus

However, if the ME residual between the reference picture and the block of an encoding target picture is sufficiently low, it can be considered that there is little encoding distortion, so that it is not necessary to perform motion prediction for the corresponding block of the encoding target picture and remaining reference pictures. Therefore, if the order in which motion prediction is performed is determined based on the information indicative of the proportion of the parallax prediction to the temporal prediction and then the motion prediction is terminated based on the ME error, unnecessary movement is skipped, so that the encoding process can be rapidly performed.

Here, if the motion prediction is performed in the order of the higher proportion of the parallax prediction and the temporal prediction, it is possible to obtain efficiency which is close to the efficiency obtained when the motion prediction is performed in the order in which encoding distortion is small, so that probability that the motion prediction using the remaining reference pictures can be skipped is high, and the high speed process can be expected. Further, for each macroblock, a reference picture, which is referred to by an immediately previous picture, stores information which indicates which parallax prediction or the temporal prediction was selected. The motion prediction is performed in such a way that the information indicative of the prediction selected as described above is stored, and that each macroblock of a subsequent picture initially uses a reference picture corresponding to the prediction which was selected in the macroblock in the same location as that of an immediately previous picture. If the motion prediction is performed as described above, probability that remaining motion prediction can be skipped in the picture encoding apparatus 10 is high, such that the high speed process can be expected.

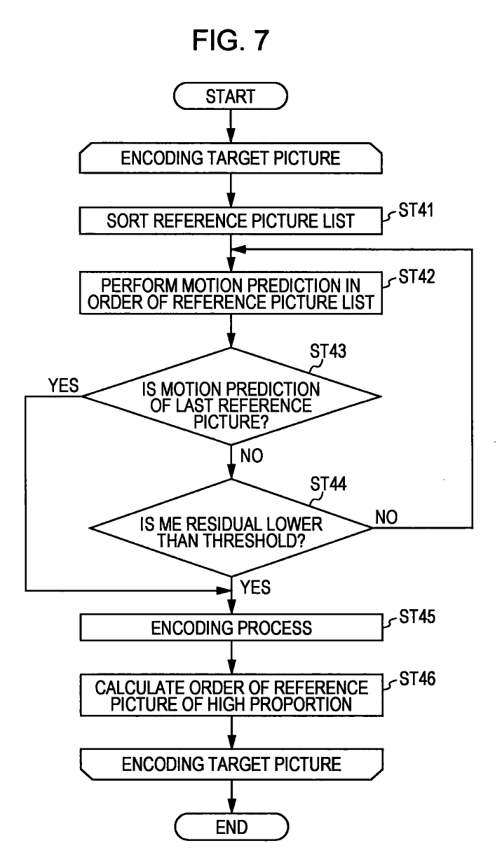

FIG. 7 is a flowchart illustrating an operation when a rapid encoding process is promoted based on information indicative of the proportion of the parallax prediction to the temporal prediction.

In step ST41, the picture encoding apparatus 10 sorts the reference picture list. The picture encoding apparatus 10 sorts the reference picture list in the order of prediction of proportion which is high in the pictures which were encoded before the encoding target picture is encoded, and proceeds to step ST42.

In step ST42, the picture encoding apparatus 10 performs motion prediction in the order of the reference picture list, and proceeds to step ST43.

In step ST43, the picture encoding apparatus 10 determines whether the prediction is the motion prediction of the last reference picture. The picture encoding apparatus 10 proceeds to step ST45 when the reference picture used for motion prediction is the last reference picture, and proceeds to step ST44 when the reference picture used for motion prediction is not the last reference picture.

In step ST44, the picture encoding apparatus 10 determines whether the ME residual is lower than a threshold. The picture encoding apparatus 10 proceeds to step ST45 when the ME residual is lower than a preset threshold, that is, when it is considered that there is little encoding distortion. Further, the picture encoding apparatus 10 returns to step ST42 when the ME residual is greater than the threshold.

In step ST45, the picture encoding apparatus 10 performs the encoding process, and proceeds to step ST46.

In step ST46, the picture encoding apparatus 10 calculates the order of reference pictures in which the proportion thereof is high. The picture encoding apparatus 10 calculates the proportion of the parallax prediction to the temporal prediction such that the reference picture list can be sorted in the order of prediction of proportion which is high when the subsequent encoding target picture is encoded, and stores the order of the reference picture in the order of prediction of proportion which is high.

As described above, the picture encoding apparatus 10 sorts the reference picture list of the picture encoded before the encoding target picture is encoded, for example, the picture encoded immediately before, in the order of prediction of proportion which is high. Furthermore, the picture encoding apparatus 10 performs the motion prediction in the order of the reference picture list obtained after the sorting, so that the reference picture which enables the ME residual to be sufficiently small can be rapidly detected. Further, when the reference picture which enables the ME residual to be sufficiently small is detected, the motion prediction is skipped, so that the picture encoding apparatus 10 can rapidly perform the encoding process.

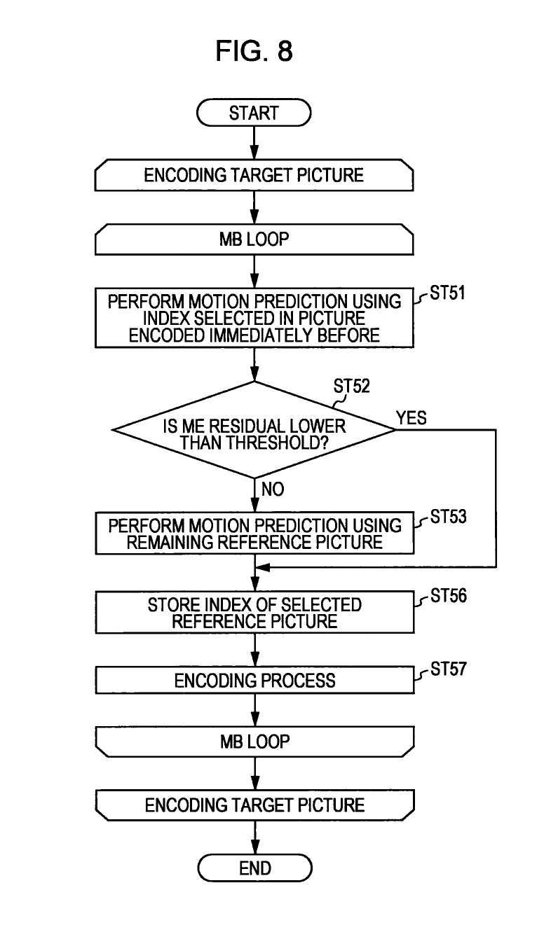

FIG. 8 is a flowchart illustrating an operation when a rapid encoding process is promoted based on information indicative of a reference picture which is referred to for each macroblock.

In step ST51, the picture encoding apparatus 10 performs the motion prediction using an index selected in a picture which was encoded immediately before. The picture encoding apparatus 10 uses an index selected in the macroblock at the same location as that of the picture which was encoded immediately before and performs the motion prediction using a reference picture indicated by the index, and proceeds to step ST52.

In step ST52, the picture encoding apparatus 10 determines whether the ME residual is lower than a threshold. The picture encoding apparatus 10 proceeds to step ST56 when the ME residual is lower than the preset threshold, and the picture encoding apparatus 10 proceeds to step ST53 when the ME residual is greater than the threshold.

In step ST53, the picture encoding apparatus 10 performs the motion prediction using the remaining reference pictures. The picture encoding apparatus 10 performs the motion prediction using the reference pictures, which are not used for the motion prediction, in the order of the reference picture list, selects a reference picture which enables the ME residual to have the smallest value, and proceeds to step ST56.

In step ST56, the picture encoding apparatus 10 stores the index of the selected reference picture. The picture encoding apparatus 10 stores the index indicative of the reference picture of the index selected from the picture encoded immediately before or the reference picture selected when the ME error is less than the threshold, and proceeds to step ST57.

In step ST57, the picture encoding apparatus 10 performs the encoding process. The picture encoding apparatus 10 performs the encoding process using the selected reference picture, and terminates the encoding of the macroblock.

As described above, the picture encoding apparatus 10 performs the motion prediction using the index of the reference picture selected in the picture encoded immediately before for each macroblock. Therefore, in the case of a similar picture, it is not necessary to perform motion prediction using a reference picture other than the reference pictures indicated by the index, so that the picture encoding apparatus 10 can rapidly process the encoding process.

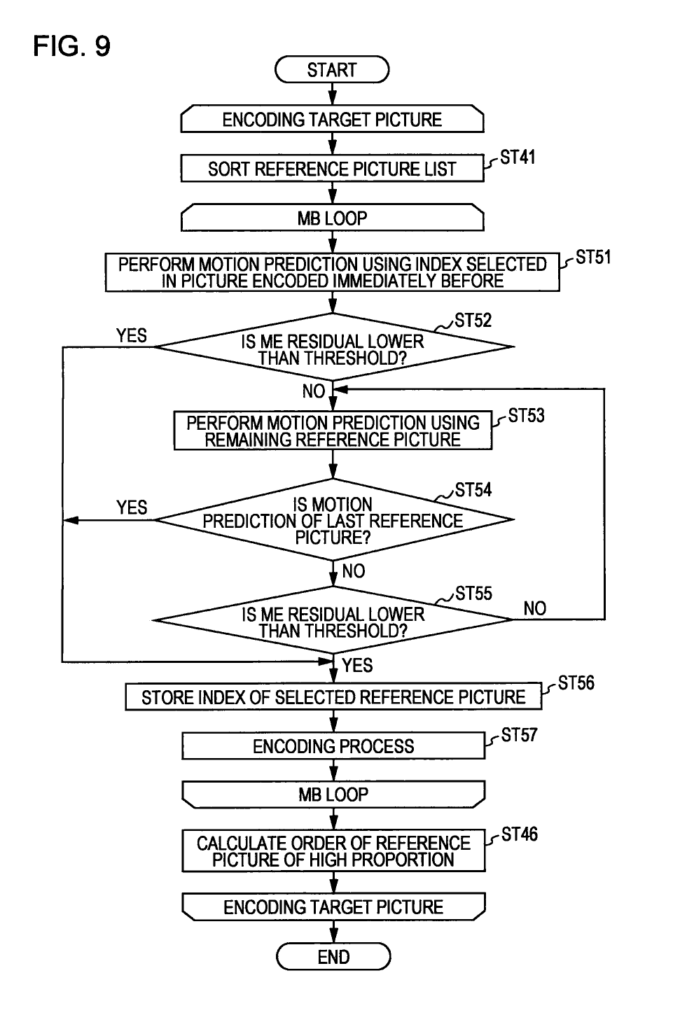

FIG. 9 is a flowchart illustrating an operation when a rapid encoding process is promoted based on information indicative of the proportion of the parallax prediction to the temporal prediction and information indicative of a reference picture selected for each macroblock. Meanwhile, the same reference numerals are used to designate the processes which correspond to FIGS. 7 and 8 in FIG. 9.

In step ST41, the picture encoding apparatus 10 sorts the reference picture list. The picture encoding apparatus 10 sorts the reference picture list in the order of prediction of proportion which is high in the picture which was encoded before the encoding target picture is encoded, and performs a process on each macroblock of the encoding target picture. In step ST51 of the process performed on each macroblock, the picture encoding apparatus 10 performs the motion prediction using the index selected in the picture encoded immediately before, and proceeds to step ST52.

In step ST52, the picture encoding apparatus 10 determines whether the ME residual is less than a threshold. The picture encoding apparatus 10 proceeds to step ST56 when the ME residual is less than the preset threshold, and proceeds to step ST53 when the ME residual is greater than the preset threshold.

In step ST53, the picture encoding apparatus 10 performs the motion prediction using remaining reference pictures. The picture encoding apparatus 10 performs the motion prediction using the reference pictures which were not used in the motion prediction in the order of the reference picture list, selects a reference picture in which the value of the ME residual is the smallest, and proceeds to step ST54.

In step ST54, the picture encoding apparatus 10 determines whether the motion prediction corresponds to the motion prediction of the last reference picture. The picture encoding apparatus 10 proceeds to step ST56 when the reference picture used for the motion prediction is the last reference picture, and proceeds to step ST55 when the reference picture used for the motion prediction is not the last reference picture.

In step ST55, the picture encoding apparatus 10 determines whether the ME residual is less than the threshold. The picture encoding apparatus 10 proceeds to step S56 when the ME residual is less than the threshold, and returns to step ST53 when the ME residual is greater than the threshold.

In step ST56, the picture encoding apparatus 10 stores the index of the selected reference picture. The picture encoding apparatus 10 stores the reference picture of the index selected in the picture encoded immediately before or the index indicative of the reference picture selected when the ME error is less than the threshold, and proceeds to step ST57.

In step ST57, the picture encoding apparatus 10 performs the encoding process. The picture encoding apparatus 10 performs the encoding process using the selected reference picture.

When the above-described encoding is performed for each macroblock and the encoding performed on the macroblock of all the encoding target pictures is terminated, the process proceeds to step ST46.

In step ST46, the picture encoding apparatus 10 calculates the order of reference picture the proportion of which is high. The picture encoding apparatus 10 calculates the proportion of the parallax prediction to the temporal prediction when a subsequent encoding target picture is encoded such that the reference picture list is sorted in the order of prediction of proportion which is high, and stores the orders of the reference pictures in the order of prediction of proportion which is high.

When the above-described process is performed on each picture and the ME residual is less than the threshold, the motion prediction using a new reference picture is skipped, such that time taken to encode the encoding target picture can be reduced. Therefore, the picture encoding apparatus 10 can rapidly perform encoding without reducing encoding efficiency.

6. Case of Software Processing

The above-described series of processes can be performed using hardware, software, or the combination thereof. When such a process is performed using software, the process is performed in such a way that a program, in which the sequence of the process is recorded, is installed in the memory of a computer, which is embedded in dedicated hardware. Further, the process can be performed in such a way that a program is installed in a general-purpose computer capable of executing various types of processes.

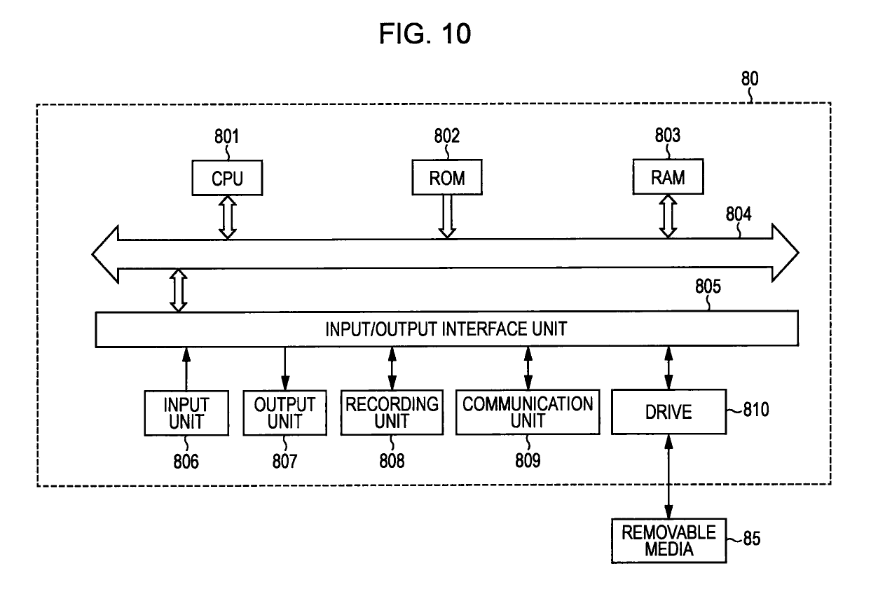

FIG. 10 is a view illustrating the configuration of a computer apparatus which executes the above-described series of processes using a program. The CPU 801 of a computer apparatus 80 executes the various types of processes based on a computer program recorded in a ROM 802 or a recording unit 808.

A RAM 803 appropriately stores computer programs or data executed by the CPU 801. The CPU 801, the ROM 802, and the RAM 803 are connected to each other via a bus 804.

Further, an input/output interface 805 is connected to the CPU 801 via the bus 804. An input unit 806, such as a touch panel, a keyboard, a mouse, or a microphone, and an output unit 807, including a display or the like, are connected to the input/output interface 805. The CPU 801 executes various types of processes based on instructions input from the input unit 806. Further, the CPU 801 outputs the results of the process to the output unit 807.

The recording unit 808 connected to the input/output interface 805 includes, for example, a hard disk, and stores computer programs, executed by the CPU 801, or various types of data. A communication unit 809 communicates with external apparatuses over a network, such as the Internet or a local area network, or via a wired or wireless communication media called digital broadcasting. Further, the computer apparatus 80 may obtain a computer program via the communication unit 809, and record the computer program in the ROM 802 or the recording unit 808.

When a removable media 85, such as a magnetic disk, an optical disc, a magnet-optical disc, or a semiconductor memory, is mounted, a drive 810 drives the removable media and obtains a recorded computer program or data. The obtained computer program or data is transmitted to the ROM 802, the RAM 803, or the recording unit 808 as necessary.

The CPU 801 reads and executes the computer program which performs the above-described series of processes, and encodes a picture signal, recorded in the recording unit 808 or the removable media 85, or a picture signal, supplied via the communication unit 809. Meanwhile, the various types of processes may be performed not only in time series as described above but also in parallel or individually according to the processing capabilities of an apparatus which executes the process if necessary.

Further, the present disclosure should not be interpreted as being limited to the above-described embodiments. For example, the present disclosure is not limited to the case where the feature quantity is calculated based on a single picture encoded immediately before, and the feature quantity may be calculated based on a plurality of pictures encoded immediately before. In this case, even when an influence, such as noise, is generated in the single picture encoded immediately before, the feature quantity is calculated using the plurality of pictures, so that the influence, such as noise, may be decreased. The embodiments of the present disclosure disclose the present disclosure in the form of exemplification, and it is apparent that those skilled in the art may modify or substitute without departing from the gist of the present disclosure. That is, consideration should be made of the claims in order to determine the gist of the present disclosure.

The present disclosure contains subject matter related to that disclosed in Japanese Priority Patent application JP 2011027386 filed in the Japan Patent Office on Feb. 10, 2011, the entire contents of which are hereby incorporated by reference.

What is claimed is:

1. A picture encoding apparatus comprising:
a feature quantity generation unit which, when a picture is encoded, generates feature quantity indicative of a dominant one of parallax prediction using reference pictures the viewpoints of which are different from each other and temporal prediction using reference pictures in a temporal direction; and
a reference picture list creation unit which, when an encoding target picture is encoded, updates a reference picture list of the reference pictures based on the feature quantity generated in a picture which was encoded before the corresponding encoding target picture is encoded.

2. The picture encoding apparatus according to claim 1, wherein the reference picture list creation unit updates the reference picture list, and assigns indexes having short code lengths to the reference pictures used in the dominant prediction.

3. The picture encoding apparatus according to claim 2, wherein the feature quantity generation unit uses a proportion of a block for which the parallax prediction is performed to a block for which the temporal prediction is performed as the feature quantity in the picture.

4. The picture encoding apparatus according to claim 2, further comprising:
a motion prediction unit which performs motion prediction using the reference pictures,
wherein, when the encoding target picture is a bidictionally-predictive picture, the feature quantity generation unit uses a prediction error for each reference picture, obtained by performing the motion prediction on each reference picture of the temporal prediction, as the feature quantity.

5. The picture encoding apparatus according to claim 4, wherein the feature quantity generation unit uses a prediction error, obtained by performing the motion prediction using the reference pictures of the parallax prediction, as the feature quantity.

6. The picture encoding apparatus according to claim 1, further comprising:
a motion prediction unit which performs motion prediction using the reference pictures,
wherein the motion prediction unit performs motion prediction using the reference pictures in an order of the dominant predictions, and terminates the motion prediction of the encoding target picture when a prediction error is lower than a preset threshold.

7. The picture encoding apparatus according to claim 1, further comprising:
a motion prediction unit which performs motion prediction using the reference pictures,
wherein the motion prediction unit performs motion prediction using the reference pictures each represented by an index selected by a block at a same location as that of an encoding target block in a picture which was encoded immediately before the encoding target picture is encoded.

8. The picture encoding apparatus according to claim 7,
wherein the motion prediction unit terminates the motion prediction of the encoding target block when a prediction error of the motion prediction using the reference pictures each represented by the index selected by the block at the same location is lower than a preset threshold.

9. The picture encoding apparatus according to claim 8, wherein the motion prediction unit performs the motion prediction using the reference pictures in an order based on the index when the prediction error of the motion prediction using the reference pictures each represented by the index selected by the block at the same location is greater than the preset threshold.

10. A picture encoding method, comprising:
generating feature quantity indicative of dominant one of parallax prediction using reference pictures viewpoints of which are different from each other and temporal prediction using reference pictures in a temporal direction when a picture is encoded; and
when an encoding target picture is encoded, updating a reference picture list of the reference pictures based on the feature quantity generated in a picture which was encoded before the corresponding encoding target picture is encoded.

11. A program which causes a picture to be encoded in a computer, the program comprising:
generating feature quantity indicative of dominant one of parallax prediction using reference pictures viewpoints of which are different from each other and temporal prediction using reference pictures in a temporal direction when a picture is encoded; and
when an encoding target picture is encoded, updating a reference picture list of the reference pictures based on the feature quantity generated in a picture which was encoded before the corresponding encoding target picture is encoded.
